(19) United States
(12) Patent Application Publication
(10) Pub. No.: US 2018/0269944 A1
(43) Pub. Date: Sep. 20, 2018

(54) A MULTIPLE RANK MODULATION SYSTEM

(71) Applicant: UNIVERSITY OF KWAZULU-NATAL, WESTVILLE (ZA)

(72) Inventors: HONGJUN XU, DURBAN (ZA); PETER ODERO AKUON, UMBILO (ZA)

(21) Appl. No.: 15/756,564

(22) PCT Filed: Aug. 19, 2016
(86) PCT No.: PCT/IB2016/054981

§ 371 Date: Feb. 28, 2018

(30) Foreign Application Priority Data
Sep. 1, 2015 (GB) 1515437.0

(51) Int. Cl. H04B 7/06

(52) U.S. Cl. CPC H04B 7/0608; H04B 7/0691

(57) ABSTRACT

A system and method for multiple rank modulation transmission in a Multiple-Input Multiple-Output (MIMO) or Multiple-Input Single-Output (MISO) system is provided. The method includes receiving at a transmitter, a signal with a plurality of bits and separating the received signal into a rank index bit block and a signal modulation bit block. The signal modulation bit block is encoded in a signal modulation scheme for transmission. The rank index bit block is used to select a rank to be activated, wherein the activated rank contains at least one active transmitter antenna and the encoded signal modulation bit block is transmitted via the activated rank being at least one activated transmitter antenna. The transmitted encoded signal modulation bit block is received via the receive antenna and a receiver a rank index and a transmitted symbol estimated from the received signal. The signal modulation bit block is finally decoded.

### BACKGROUND OF THE INVENTION

The present invention relates generally to a Multiple Rank Modulation (MRM) method, and transmitting and receiving apparatuses using the same in a conventional Multiple Input Multiple Output (MIMO) or Multiple Input Single Output (MISO) system. More particularly, the present invention relates to a transmitting apparatus using an MRM method and a receiving apparatus using an MRM detection method based on Maximum Likelihood (ML) in a MIMO or MISO system.

Spatial modulation (SM) being a recent technology has several advantages over other MIMO schemes. In addition to modulation signal, SM utilizes antenna index as a source of information to increase transmission capacity and SM also avoids interchannel interference (ICI) and some level of synchronization.

However, the use of a transmit antenna index as a source of information has the implication that if the channels look alike, then spatial information may be lost completely. This is because just like all the variants of SM technology like SSK, GSM, GSSK and DSM, the SM detector uses the shape of each channel to detect spatial information. In fact, there may be cases in the user market that may lead to reception of signals that look alike due to similarity of channels e.g. in signal correlation.

In enhanced spatial modulation (ESM), the received signal power can be used to detect the spatial information where each activated transmit antenna transmits at a known power level. However, this leads to other implementation implications at the transmitter and feedback may be required from the receiver. Also, in polar coded spatial modulation (PCSM), different rates can be used to transmit known frozen bits and then use the rate or capacity information to decode the spatial bits with minimal error or in the control channel. However, coset-coding is required to achieve this technique.

Accordingly, there is a need for an improved spatial modulation method, and transmitting and receiving apparatuses using Multiple Rank modulation for reducing high demodulation complexity and errors in the spatial domain, while providing additional capacity and data rates.

### SUMMARY OF THE INVENTION

According to a first example embodiment there is provided a Multiple rank modulation transmission method in a Multiple-Input Multiple-Output (MIMO) or Multiple-Input Single-Output (MISO) system, the method including:
receiving at a transmitter, a signal with a plurality of bits and separating the received signal into a rank index bit block and a signal modulation bit block;
encoding the signal modulation bit block in a signal modulation scheme for transmission;
using the rank index bit block to select a rank to be activated, wherein the activated rank contains at least one active transmitter antenna; and
transmitting the encoded signal modulation bit block via the activated rank being at least one activated transmitter antenna.
receiving the transmitted encoded signal modulation bit block via the receive antenna and a receiver;
estimating a rank index and a transmitted symbol from the received signal; and
decoding the signal modulation bit block.

According to another example embodiment there is provided a Multiple-Input Multiple-Output (MIMO) or Multiple-Input Single-Output (MISO) system using Multiple rank modulation and Multiple rank modulation detection, the system comprising:
a ranking modulator for encoding a multi-symbol signal into an index of an activated rank;
a plurality of transmitter antennas for sending a modulated signal of a signal modulation encoder through one activated rank containing at least one antenna during a unit time;
a plurality of receiver antennas for receiving the modulated signal from the transmitter antennas;
a detector for estimating a rank index and a transmitted symbol from the received signal; and
a ranking demodulator for decoding the signal of the ranking modulator.

### BRIEF DESCRIPTION OF THE DRAWINGS

FIG. 1 is a block diagram of a MIMO system using Multiple Rank Modulation (MRM) according to an example embodiment of the present invention;

FIG. 2 is a block diagram of a MIMO system using Multiple Rank Modulation (MRM) with rank mapping according to a classic embodiment of the present invention; and

FIGS. 3-5 illustrate simulation results of an example embodiment of the present invention.

### DESCRIPTION OF EMBODIMENTS

The embodiments of the present invention are intended to provide a system and method for increasing spectral efficiency.

For purposes of this description, the technology will be referred to as Multiple Rank Modulation (MRM).

It should be noted that, the transmitter elements can be composed of transmit antennas or ports or waveguides within a single antenna as observed in dual-polarized antennas or loudspeakers or ultrasound transmitters, multiple LEDs (light emitting diodes) etc.

MRM utilizes a rank index of a multiple system activated among a plurality of multiple ranks as an information source.

For purposes of this description, rank index means the number of antennas or signal ports that are transmitting.

A signal with a plurality of bits is modulated to multiple symbols in a signal domain and a ranking domain. In the modulation signal domain, a signal modulation bit block is encoded on a signal constellation corresponding to a given modulation scheme.

In the ranking domain, a rank bit block is encoded according to the index of a rank to be activated. The selected rank may contain one or more transmit antennas, but each rank contains a different number of transmitting elements or antennas. All the transmit antennas in the activated rank are used to transmit the same information.

It is deeply inventive that MRM uses multiple channel shapes to determine the ranking information and since each rank has different number of channels, the ranking information will be detected even if the channels look alike, i.e. shapes unknown, as long as the number of received channels are known.

The MRM method uses one activated rank per unit time in a MIMO system to transmit the same information. As such, just like SM, MRM avoids ICI compared to conventional MIMO. Transmission capacity measured in bits per second per hertz is increased because the MRM method exploits the index of the activated rank as an information source. This will be described in more detail below.

Spatial modulation (SM) being a recent technology has several advantages over other MIMO schemes. In addition, SM utilizes antenna index as a source of information to increase transmission capacity and SM also avoids ICI and synchronization. However, the following are major concerns in SM.
(1) The spectral efficiency (SE) of SM increases logarithmically with the number of transmit antennas (Nₜ) i.e. SE=log₂(MNₜ) where M denotes the modulation index. Therefore, the data rates in SM are lower than VBLAST.
(2) Also, the number of transmit antennas is required to be a power of two. This requirement needs large number of antennas. However, fractional bit encoded (FB-SM), generalized spatial modulation (GSM) and generalized space shift keying (GSSK) can be used to reduce the number of transmit antennas.
(3) In SM, the wireless channel is the spatial modulator and the detection process may lead to error in the spatial domain in the case that the channels are similar. To this end, power detection has been proposed in enhanced spatial modulation (ESM). In ESM, the transmit element is detected using the knowledge of the power allocated at the transmitter in order to decode the spatial bits i.e. the location of the active transmitter element is detected using knowledge of the power allocated to the transmitter elements. Similarly, in polar coded spatial modulation (PCSM), the channel rate or the number of bits in the frozen set can be used to relay spatial information to the receiver without encountering any channel errors.

In the proposed invention, spatial information is not modulated by the random channel. Rather, spatial information is conveyed by the number of RF chains. Therefore, the detection for information in MRM reduces to the conventional amplitude and phase modulation (APM) schemes.

MRM exploits different transmit MIMO RF chains to convey information to the receiver. In one method, known as spatial MRM, incoming information bits at the transmitting end are used to select the number of transmit chains, after which known symbols are transmitted.

Thus, the receiver decodes the information based on the rank or the number of received RF chains.

In spatial MRM, the transmitted symbols are just a means of performing transmission in order to inform the receiver about the spatial information. In another method, modulation symbols are transmitted to the receiver where incoming information bits select both the modulation symbols and the number of transmit RF chains or transmit antennas. Thus, we have the modulation domain and the ranking domain. As a result, there are multiple domains. In this second method, the receiver detects both the rank and the transmitted symbols. It is important to note that in this method, all the transmit antennas in the selected rank transmit the same information. The analytical framework for MRM is proposed and derived.

Therefore, in the embodiment, MRM is described that uses a novel technique to convey spatial information to the receiver.

MRM utilizes the index of a multiple rank activated among a plurality of multiple ranks as an information source. A signal with a plurality of bits is modulated to multiple symbols in a modulation signal domain and a ranking domain. In the modulation signal domain, a signal modulation bit block is encoded on a signal constellation corresponding to a given modulation scheme. In the ranking domain, a rank bit block is encoded according to the index of a rank to be activated.

The selected rank may contain one or more transmit antennas but each rank contains different quantities of known antennas. All the transmit antennas in the activated rank are used to transmit the same information. It is deeply inventive that MRM uses multiple channel shapes to determine the ranking information and since each rank has different number of channels, the ranking information will be detected even if the channels look alike, i.e. shapes unknown, as long as the number of received channels are known.

To enhance higher data rate, MRM can be combined with OFDM. Each OFDM subcarrier is sent through one transmitter antenna in each predetermined time interval, while the other ranks are off during the time interval. The combination of MRM and OFDM reduces OFDM demodulation complexity according to the SM.

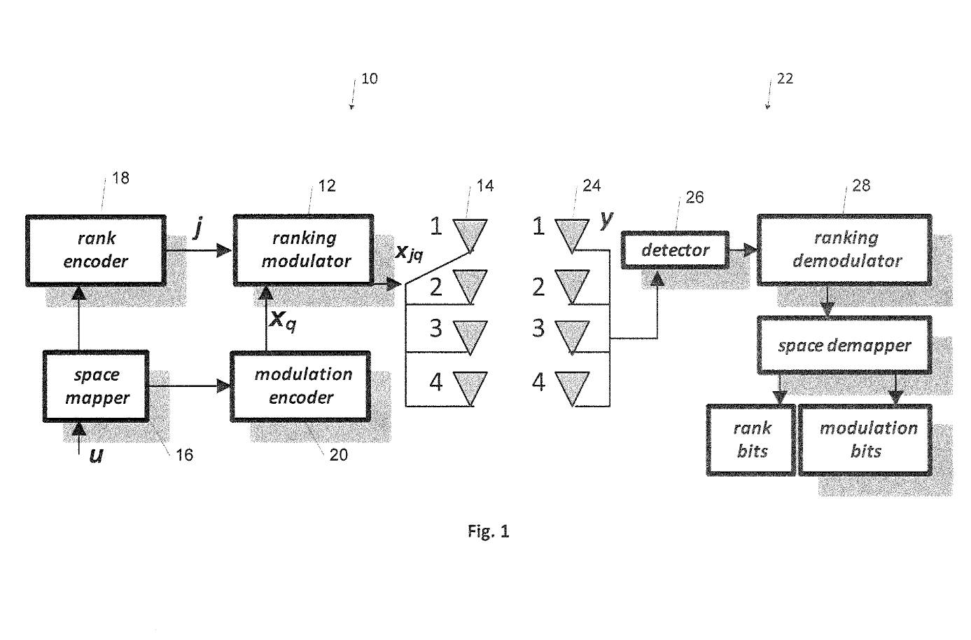

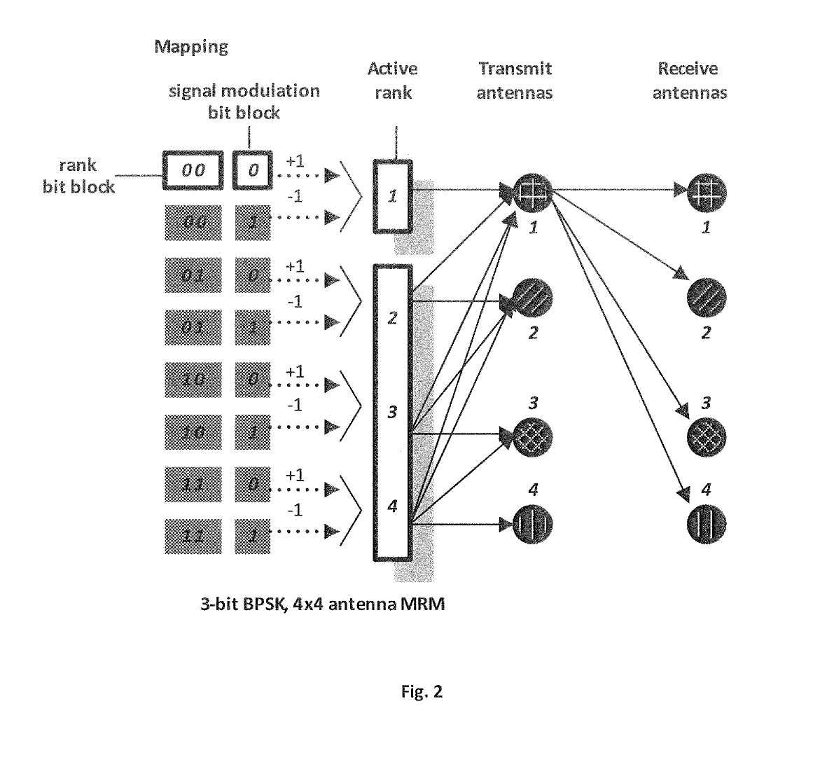

With reference to FIGS. 1 and 2, an MRM method and a transmitter using the MRM method in a MIMO system will be described.

FIG. 1 is a block diagram of a MIMO system according to an exemplary embodiment of the present invention and FIG. 2 illustrates an MRM method according to an embodiment of the present invention.

Referring to FIG. 1, a transmitter 10 according to an embodiment of the present invention includes a ranking modulator 12 and a plurality of transmitter antennas 14.

The transmitter 10 also includes a space mapper 16, a rank index encoder 18, and a signal modulation encoder 20.

The space mapper 16 separates an information signal including a plurality of bits into a rank bit block and a signal modulation bit block.

The signal modulation encoder 20 encodes the signal modulation bit block on a signal modulation constellation.

The rank index encoder 18 encodes the rank bit block with the index of an activated rank.

The plurality of antennas 14 sends the modulated signal to a receiver through one rank activated per unit time according to the plurality of antennas in the activated rank.

For example, an input signal u includes N bits. The ranking modulator 12 spatially modulates u to x. The signal x is a signal with Nₜ symbols (Nₜ is the total number of transmit antennas).

The ranking modulator 12 applies a signal modulation constellation value to a symbol position corresponding to the activated antennas in the activated rank in x while setting 0s at the other symbol positions of x corresponding to the remaining inactive antennas.

An antenna index is denoted by j and a transmission symbol is denoted by x_{q}. A first (1^{st}) rank among the plurality of ranks sends the symbol x_{q} on a MIMO channel with an Hchannel matrix. H can be modeled to a flat Rayleigh fading channel. Any other channel not cited can be modelled as well. The channel modeling is dependent on the degree of existence of Line-Of-Sight (LOS) between a transmitter antenna and a receiver antenna.

It is now assumed that the statistic flat fading Rayleigh channel matrix is flat over all modeled frequency components.

A vector of received signal is given as

y=hx+n (1).

Referring now to FIG. 2, the embodiments of the present invention use the index of an active rank as an information source. As an illustrative example, given four transmitter antennas, then four cases can be represented as 2-bit information.

This information is shown in FIG. 2 as a rank bit block representing an active rank and active antenna one, and inactive ranks and inactive antennas two, three and four.

An embodiment of the present invention also uses a signal modulation constellation diagram as an information source. One-bit information on a BPSK constellation diagram includes +1 and −1. In M-QAM, M cases are represented as m-bit information m=(log₂(M)).

In FIG. 2 a signal modulation bit block is mapped to corresponding antennas in the selected active rank.

Signal modulation and ranking modulation (RM) are applied to an n-bit input signal. Bits corresponding to the rank bit block are encoded by RM. That is, a vector signal having as many symbols as the total number of antennas is generated such that a signal modulation symbol value is set at the symbol positions corresponding to the index of a rank to be activated.

Bits corresponding to the signal modulation bit block in the input signal are encoded by signal modulation. That is, 0s are set at the symbol positions corresponding to the inactive antennas in the vector signal.

Four bits per symbol can be sent in the manner depicted in Table 1.

TABLE I
EXAMPLE OF THE MRM MAPPER RULE

| | | | | BPSK |
|---|---|---|---|---|
| Input | Antenna | Antenna | | Modulation |
| bits | bits | Index/indices | Rank | bit |
| 000 | 00 | 1 | 1 | 1 |
| 001 | 00 | 1 | 1 | −1 |
| 010 | 01 | 1, 2 | 2 | 1 |
| 011 | 01 | 1, 2 | 2 | −1 |
| 100 | 10 | 1, 2, 3 | 3 | 1 |
| 101 | 10 | 1, 2, 3 | 3 | −1 |
| 110 | 11 | 1, 2, 3, 4 | 4 | 1 |
| 111 | 11 | 1, 2, 3, 4 | 4 | −1 |

For example in Table 1, in the conventional form of MRM, the following example system can be used to achieve four bits per symbol transmission in MRM;
1. BPSK and eight transmit antennas;
2. 4QAM and four transmit antennas;
3. 8QAM and two transmit antennas;
4. 16QAM and one transmit antenna; where

The number of bits transmittable by MRM is given as;

The number of bits in the modulation domain for MQAM is given as mₛ=log₂(M) where M is the cardinality of MQAM which denotes the number of cases representable on a signal modulation constellation.

Similarly, the number of bits in the ranking domain is given as mₐ=log₂(Nₜ), where Nₜ is the number of transmitter antennas or the number of cases representable on a ranking domain.

Referring back to FIG. 1, a receiver 22 according to an example embodiment of the present invention includes receiver antennas 24, a detector 26, and a ranking demodulator 28. The receiver antennas 24 receive signals from the transmitter antennas 14.

The detector 26 estimates the index of an active rank and a transmitted symbol by maximum-likelihood (ML).

This means the number of antennas transmitting is estimated by the detector 26. The number of antennas transmitting is the rank value.

The ranking demodulator 28 demodulates the received signal.

An ML algorithm of an embodiment of the present invention efficiently estimates the rank meaning how many antennas actually transmitted, thereby reducing the complexity of the receiver compared to a conventional algorithm for MIMO. According to the ML algorithm, a received vector y is multiplied by a channel path gain or gains of all the ranks repeatedly by the channel gains for each rank. The index of the activated transmitter antennas and the transmitted symbol at an instant are estimated by the following;

There are two main processes at the detector. One is to determine the rank of the transmit signals and the other is to detect the transmitted signals. At the receiver, since the symbols are equally likely, the optimal MRM detector is used to perform joint detection of the modulation symbol vector x_{\hat{q}} and transmit rank \hat{r} based on maximum-likelihood (ML) technique and this is written as

$$[ {\hat{k}}_{\hat{r}} ; \hat{j} , {x}_{\hat{q}} ] = arg {max}_{j , q} P ( y \vert H , {x}_{jq} ) \\ [ {\hat{k}}_{\hat{r}} ; \hat{j} , {x}_{\hat{q}} ] = arg {max}_{j , q} \sqrt{\hat{\overline{γ}}} {‖ {\hat{h}}_{j} , {x}_{q} ‖}_{F}^{2} - 2 Re \{ {y}^{H} {\hat{h}}_{j} , {x}_{q} \} \qquad ( 2 )$$

where ∥·∥_{F} denotes the Frobenius norm operator and the conditional pdf of y given H and x_{q} is written as

$$P ( y \vert H , {x}_{jq} ) = \frac{1}{{π}^{{N}_{r}} {σ}_{N}^{2 {N}_{r}}} exp ( \frac{{‖ y - {Hx}_{jq} ‖}_{F}^{2}}{{σ}_{N}^{2}} ) \qquad ( 3 )$$

and where j∈χᵣ represents the estimated antenna indices and \hat{k}_{\hat{r}} denotes the estimated kth point in the (Nₜ×M) constellation belonging to rank \hat{r} with minimum distance in (2) and ĥⱼ, denotes the estimated channel.

In MRM, the rank bits are demapped according to \hat{r} while the modulation bits are demapped according to x_{\hat{q}} following Table I above. Also, the power of the received signals can be used to decode the rank index.

For example, the transmitter rank index is used to decode the rank bit block and the transmitted symbol is used to decode the signal modulation bit block. The original signal is demodulated by combining the rank bit block with the signal modulation bit block.

As described above, an embodiment of the present invention estimates the rank index by the number of different channel paths.

The detector estimates a rank index and a transmitted symbol from the received signal. The ranking demodulator decodes a rank bit block using the estimated rank index and decodes a signal modulation bit block using the estimated transmitted symbol.

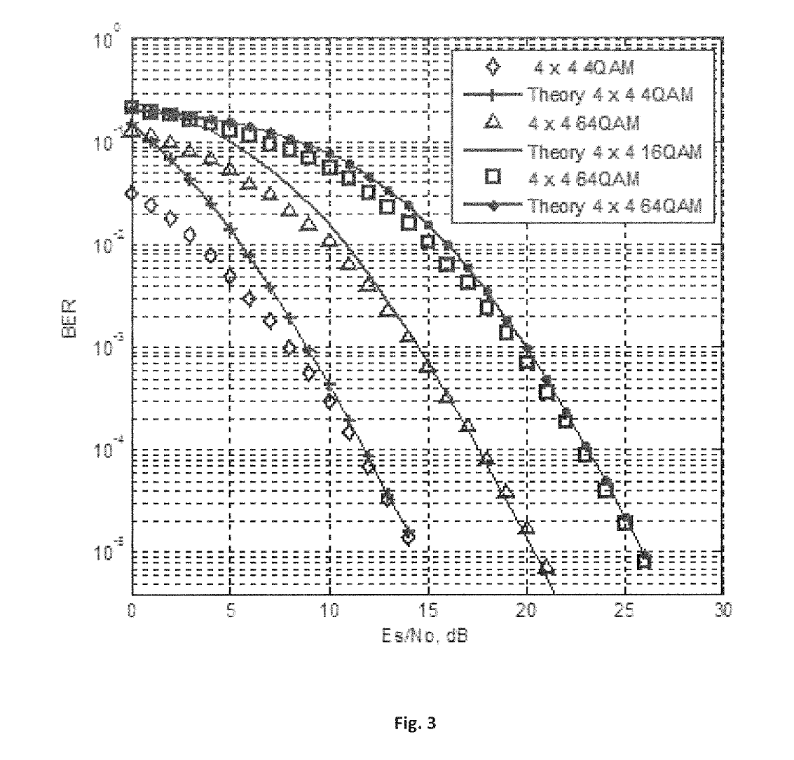

The simulation results of an example embodiment of the present invention will be described with reference to FIGS. 3 to 5.

In one method, simulation was performed under the assumption that the receiver has full knowledge of every channel, and antennas at the transmitter and the receiver are spaced from one another enough to avoid correlation. In the second method, the antennas at the transmitter and the receiver are assumed to be correlated. Furthermore, the total signal power is assumed constant at each transmission. When a total power P is 1 W and a noise power is σ², the reception SNR of the receiver is P/σ². The noise is AWGN with integrity in time and space. In MIMO V-BLAST transmission, the transmitter antennas are assumed to be effectively synchronized.

Furthermore, the performance of MRM for varying antenna configurations and MQAM modulation are illustrated.

In FIG. 3, MRM's performance is demonstrated by comparing the simulation results and analytical results for Nₜ=2, 4 and Nᵣ=4. The channel between the transmitter and the receiver is assumed to be uncorrelated. It is observed that the proposed analytical bounds and the simulations are a close match, especially at high SNR region.

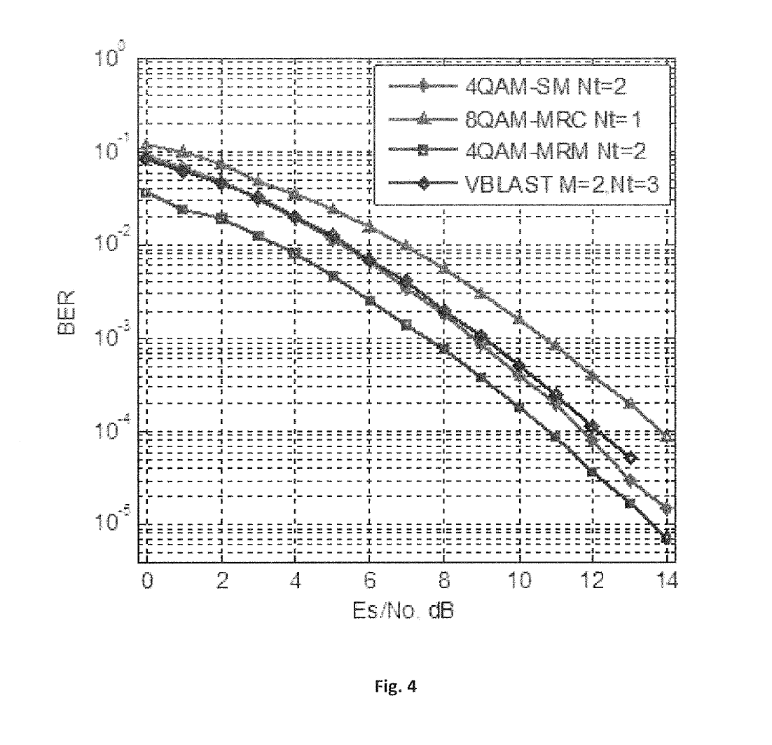

FIG. 4 illustrates the MRM's performance versus SM, VBLAST and single-input multiple-output (SIMO) system with MRC combining given that the same rate of information is relayed across the channel. The information rate is set at 3 bits/s/Hz. As such, 8-QAM modulation is used in the SIMO case and 4-QAM SM system exploiting optimal detection is compared. For VBLAST, three transmit antennas are used to simultaneously transmit binary phase-shift keying (BPSK) modulation signals. The number of receive antennas is set at Nᵣ=4. It is observed that the error performance of the SIMO system is the most degraded. Also, VBLAST offers a low error performance as compared to SM. However, MRM results in 1 dB gain over SM. This is because the detection of MRM reduces to conventional detection for modulation signals alone. Also, the error in the detection of spatial bits is negligible since the channel variances among the ranking domains have a wide gap.

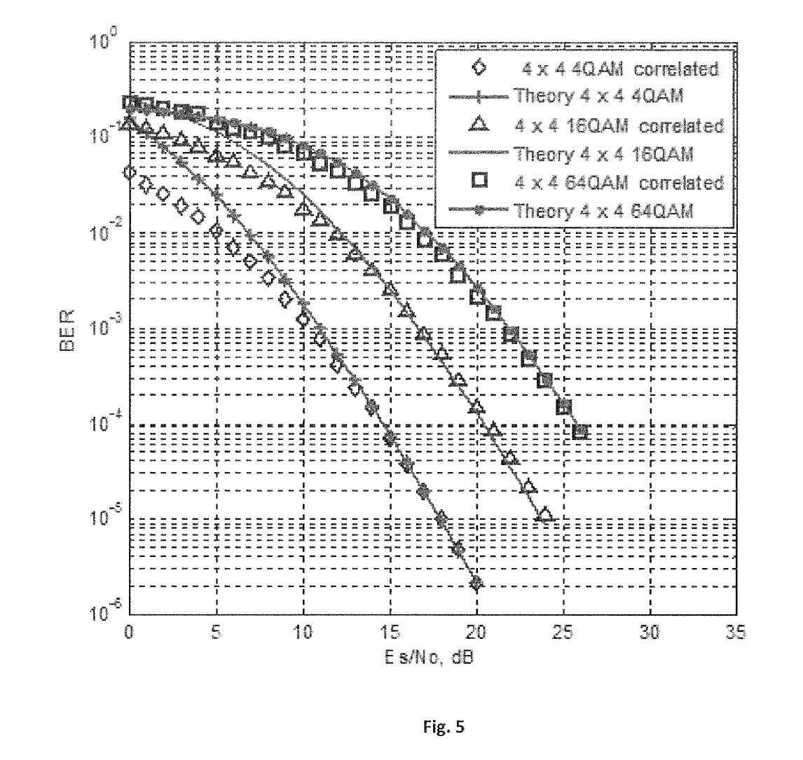

In FIG. 5, MRM's performance is demonstrated by comparing the simulation results and analytical results for Nₜ=2,4 and Nᵣ=4. Here, the channel between the transmitter and the receiver is assumed to be correlated. Also under channel correlation conditions, it is observed that the proposed analytical bounds and the simulations are a close match, especially at high SNR region. This further validates the proposed analytical framework for MRM under both uncorrelated and correlated channels.

In order to compute the receiver complexity for MRM given that the optimal detection algorithm in (3) is applied. The receiver complexity is analyzed based on the number of complex operations needed at the receiver. These operations are either a complex multiplication or addition. Similar to the SM case, the optimum MRM receiver is given by (3) whose complexity is equal to NₜM(3Nᵣ+1+Nₜ). This is because the term ∥ĥⱼx_{q}∥² in (3) requires (Nᵣ+1+nₜᵣ) complex operations, and the term γ^{H}ĥⱼ,x_{q} requires 2Nᵣ complex operations. In total, all these operations are required to be evaluated NₜM times and max, {|χᵣ|}=max{nₜᵣ}=Nₜ. It is noted that the complexity of the optimal SM decoder is given by NₜM(3Nᵣ+1).

As described above, an exemplary embodiments of the present invention activates at least one transmit antenna in a MIMO system to transmit the same symbol. Therefore, ISI at a receiver is cancelled, and transmission efficiency per unit hertz is increased using a rank constellation as information. It will be appreciated that various changes in form and details may be made therein without departing from the scope of the invention.

Besides, we show that MRM exploits spatial constellation that is larger than the number of transmit antennas. Furthermore, simulation results are presented for various data rates, antenna configuration and comparison tests are carried out for conventional SM and spatial multiplexing. The simulations are used to validate the theoretical framework and it is found that MRM leads to very minimal error in the spatial domain.

The MRM method according to an embodiment of the present invention offers higher network efficiency especially additional reliability, while taking the advantages of the SM method. In addition, the MRM method is not limited to PSK (BPSK or QPSK) and Amplitude Shift Keying (ASK), Frequency Shift Keying (FSK), and M-QAM are also available.

Thus it will be appreciated that aspect of classic embodiments of the present invention is to provide a MIMO system that does not cause ICI at a receiver and reduces spatial error.

Furthermore, classic embodiments of the present invention provide a method for increasing transmission efficiency per unit hertz using the spatial layout of a group of transmitter antennas as information and a transmitter system using the same.

In addition, classic embodiments of the present invention provide a detection method for achieving a virtual spatial gain, while reducing errors and the demodulation complexity of a conventional MIMO receiver and a receiver using the same in a MIMO system.

It should be easy for those skilled in the art to understand that, MRM can be implemented as MRM multiplexing (MRMX). MRMX method involves transmitting different signals in the modulation domain while retaining other aspects of MRM in the ranking domain. Also, MRM is also possible with a multiple input single output (MISO) system

The following description sets out the mathematical proofs in performance analysis.

A. Error Probability

In the proposed analysis, each signal from the respective transmit antennas is analyzed in its independent signal space where a symbol error only occurs due to its antenna path. Therefore, the detection of each x_{\hat{q}} is equivalent to the ML in a SIMO system. For the SIMO system, the exact SEP for square M-ary MQAM is given as

$$SEP ( e \vert \overline{γ} ) = 4 aQ ( \sqrt{\frac{b \overline{γ}}{{n}_{t}}} ) - 4 {a}^{2} {Q}^{2} ( \sqrt{\frac{b \overline{γ}}{{n}_{t}}} ) \qquad ( 4 )$$

where variance

$$a = ( 1 - \frac{1}{\sqrt{M}} ) ,$$

scaling

$$b = ( \frac{3}{M - 1} )$$

and Q(·) is the Gaussian Q-function which is known by Craig's formula as

$$Q ( x ) = \frac{1}{π} {\int }_{0}^{\frac{π}{2}} exp ( - \frac{{x}^{2}}{2 {sin}^{2} ( θ )} ) d θ .$$

By applying trapezoidal rule to Q(x) and Q²(x), the SEP can easily be simplified to the following

$${P}_{SER} ( \vert \overline{γ} ) = \frac{a}{t} [ \frac{1}{2} exp ( - \frac{b \overline{γ}}{2 {n}_{t}} ) - \frac{a}{2} exp ( - \frac{b \overline{γ}}{{n}_{t}} ) + ( 1 - a ) {\sum }_{c = 1}^{t - 1} exp ( - \frac{b \overline{γ}}{{S}_{c} {n}_{t}} ) + {\sum }_{c = t}^{2 t - 1} exp ( - \frac{b \overline{γ}}{{S}_{c} {n}_{t}} ) ] \qquad ( 5 )$$

where S_{c}=2 sin² (cπ/4t) and t refers to the number of iterations used in the approximation.

Let γᵢ denote the instantaneous SNR of the ith diversity branch defined by

$${γ}_{i} = {α}_{i}^{2} \frac{{E}_{s}}{{N}_{0 i}}$$

where αᵢ is the instantaneous fading amplitude, 2Eₛ is the average energy of the symbol and N₀ᵢ is the one sided noise power spectral density of the ith diversity branch.

Then, the probability density function (pdf) of γᵢ is written as f_{γi} and the average SNR is written as γ̅ᵢ=E{γᵢ}. If the fading process is Rayleigh, the pdf of αᵢ's is written as

$${f}_{{α}_{i}} ( r ) = \frac{2 r}{{Ω}_{i}} exp ( - \frac{{r}^{2}}{{Ω}_{i}} ) ,$$

r≥0, where Ωᵢ=E{αᵢ²} and the pdf of the instantaneous branch SNR is given by

$${f}_{{γ}_{i}} ( x ) = \{ \begin{matrix}\frac{1}{{\overline{γ}}_{i}} exp ( - \frac{x}{{\overline{γ}}_{i}} ) & ( 0 \leq x < ∞ ) \\ 0 , & otherwise\end{matrix} \qquad ( 6 )$$

where

$${\overline{γ}}_{i} = {Ω}_{i} \frac{{E}_{s}}{{N}_{0 i}} .$$

Subsequently, the SEP is averaged over a fading channel with the distribution f_{γ}(γ) of the received SNR. The average SEP is given by E_{γ}(P_{SEP}( [symbol] γ))=∫₀^{∞}P_{SEP}( [symbol] γ)f_{Z}(z,γ)dγ. Furthermore, by assuming that the branch SNR's are independent of each other and the output is additive we can compute the SEP in terms of moment generating function (MGF) which is

$${γ}_{} ( s ) = {\int }_{0}^{∞} … {\int }_{0}^{∞} exp ( - s {\sum }_{i = 1}^{{N}_{r}} {γ}_{i} ) {\prod }_{i}^{{N}_{r}} ( {f}_{γ} ( {γ}_{i} ) d {γ}_{i} ) = {\prod }_{i}^{{N}_{r}} {{γ}_{i}}_{} ( s ) \qquad ( 7 )$$

Therefore, it can be shown that the average SEP P_{SEP} of the modulation signal under ML detection is given as

$$P ( y \vert h , {x}_{q} ) = \frac{a}{t} [ \frac{a}{2} {\prod }_{l = 1}^{{N}_{r}} ( \frac{2}{b {\overline{γ}}_{l} + 2} ) - \frac{a}{2} {\prod }_{l = 1}^{{N}_{r}} ( \frac{1}{b {\overline{γ}}_{l} + 1} ) ] + \frac{a}{t} [ ( 1 - a ) {\sum }_{c = 1}^{t - 1} {\prod }_{l = 1}^{{N}_{r}} ( \frac{{S}_{c}}{b {\overline{γ}}_{l} + {S}_{c}} ) + {\sum }_{c = t}^{2 t - 1} {\prod }_{l = 1}^{{N}_{r}} ( \frac{{S}_{c}}{b {\overline{γ}}_{l} + {S}_{c}} ) ] \qquad ( 8 )$$

where the branch SNR

$${\overline{γ}}_{l} = \frac{\overline{γ}}{{n}_{t}} .$$

B. MRM BEP with Sample Covariance Matrix (SCM)

With the symbol error probability (SEP) given in (8), the bit error probability (BEP) can be derived as BEP=(y|H,x_{jq}), where b denotes the effective bits in error in the joint space. Then, we use the SCM theory to compute the number of bits in error, b.

The ML detector for the MRM system can be represented as a multiple of an nₜ-dimensional signal space. Let P(y|H,x_{jq})∝∥hx_{q}∥=1/σP(y|h,x_{q}). Also, let D be an Nₜ-dimensional zero mean random vector consisting of M observations of x_{q}. Then, the MRM detector can be considered to be composed of a search space of the noise-distance vector dₗ=\ddot{H}x_{q}, l=1, 2, . . . , M. The joint signal space for each rank can be represented in the form of a matrix ϕᵣ₌₁ of information which is written as

$${φ}_{r} = [ \begin{matrix}y - {1}_{} {x}_{1} & y - {2}_{} {x}_{1} & … & y - {{N}_{t}}_{} {x}_{1} \\ y - {1}_{} {x}_{2} & y - {2}_{} {x}_{2} & … & y - {{N}_{t}}_{} {x}_{2} \\ ⋮ & ⋮ & ⋱ & ⋮ \\ y - {1}_{} {x}_{M} & y - {2}_{} {x}_{M} & … & y - {{N}_{t}}_{} {x}_{M}\end{matrix} ] \qquad ( 9 )$$

Subsequently, we form the sample covariance matrix (SCM) S of ϕᵣ by

$${S}_{l} = \frac{1}{M} {\sum }_{l = 1}^{M} {d}_{l} {d}_{l}^{T} \qquad ( 10 )$$

where the population has M independent samples. We note that the sample variance is equal to the population variance because in the MRM detector the variance of h does not lead to error in the spatial domain but rather the number of the elements of H. Therefore, for all samples of the population, x_{q} remains independent of the change in the ranking domain and thus the average sample mean \hat{μ}_{X} of x_{\hat{q}} will be equal to its population mean μ_{X} i.e. E{\hat{μ}_{X}}=μ_{X}. In the case of conventional SM the sample covariance is given as

$${S}_{l} = \frac{1}{M - 1} {\sum }_{l = 1}^{M} {d}_{l} {d}_{l}^{T}$$

with the Bessel correction factor (M−1). This is because the sample variance differs from the population variance since two random variables are determined i.e. antenna index and modulation symbol.

Let \hat{p}₁, \hat{p}₂, . . . , \hat{p}ᵣ be the principal components of the data. Then, \hat{p}ₖ,k=1, 2, . . . , r is chosen as a linear combination of \hat{P}ₖ=aₖ^{T}D where aₖ^{T} is chosen in order to maximize that the sample variance of \hat{p}ₖ. This condition is met under the constraint that ∥a₁∥=1. For example, the sample variance of the principal component obtained from the observations p_{1,l}=aₗ^{T}dₗ is given as

$${σ}_{{\hat{p}}_{1 r}}^{2} = \frac{1}{M} {\sum }_{l}^{M} {\hat{p}}_{1 , l}^{2} = \frac{1}{M} {\sum }_{l = 1}^{M} {( {a}_{1}^{T} {d}_{l} )}^{2} = {a}_{1}^{T} {Sa}_{1} \qquad ( 11 )$$

Maximizing the first variance a₁^{T}Sa₁ is the conventional eigenvalue problem where a₁ refers to the normalized eigenvector that corresponds to the largest eigenvalue ε₁ such that σ_{\hat{p}}_{₁}²=ε₁a₁^{T}a₁=ε₁. Thus, in principle, σ_{\hat{p}}_{ₖ}² represents the kth eigenvalue for the joint space. Expanding (11) and taking its expectation reveals that

$${σ}_{{\hat{p}}_{kr}}^{2} = \frac{1}{M} {\sum }_{k = 1}^{{n}_{t}} E {\vert {k}_{} \vert}^{2} E {\vert {x}_{l} \vert}^{2} = \frac{{n}_{t}}{M} \\ {σ}_{\hat{p}}^{2} = \frac{1}{M} [ \frac{1}{M} {\sum }_{q = 1}^{M} ( {\sum }_{k = 1}^{{n}_{t}} E {\vert y - {k}_{} {x}_{l} \vert}^{2} ) ] \qquad ( 12 )$$

We note that the average error distance does not change over the MQAM symbols and thus we obtain

$${σ}_{\hat{p}}^{2} = \frac{1}{M} {\sum }_{k = 1}^{{n}_{t}} E {\vert y - {k}_{} {x}_{q} \vert}^{2} = \frac{{n}_{t}}{M} ( 1 + δ ) \qquad ( 13 )$$

where E|y−\ddot{h}ₖx_{q}|²=E|n|²+δ=1+δ for all k. The constant δ measures the variance due to other sources of error other than the Gaussian noise, e.g. channel estimation errors. However, when it is assumed that the CSI is known, i.e. hₖ=\ddot{h}ₖ, then the variance is simply given as

$${σ}_{\hat{p}}^{2} = \frac{{N}_{t}}{M} \qquad ( 14 )$$

where E[|hₖ²]=1 and E[|x_{q}|²]=1.

However, the result in (14) requires a non-symmetric relationship such that nₜ≠M. The case where nₜ=M can be analyzed as a population of two directions. The sample variance could be given as

$$\frac{{n}_{t}}{M}$$

with M independent samples or

$$\frac{M}{{n}_{t}}$$

with nₜ independent samples. As a result, it is intuitive that

$${σ}_{{\hat{p}}_{kr}}^{2} = ( \frac{{n}_{t}}{M} + \frac{M}{{n}_{t}} ) = 2$$

for nₜ=M. This result can also be analyzed from eigenvalue decomposition of two equally likely variables. In this case, it can be assumed that the joint domain is composed of two variables with a correlation coefficient of ρ=1. The two eigenvalues are given as (1+φ and (1−ρ) thus σ_{\hat{p}}_{ₖᵣ}²=(1+ρ)=2 since ρ=1.

From the inspection of (14), it is evident that computing the sample variance for all the r components results in the same eigenvalue. As a result, each principal component is given as |\hat{P}|=1/σ∥a∥D and since P(y|H, x_{jq})∝σD, the average BEP is given as

BEP={square root over (1/σ_{\hat{p}}_{ₖᵣ}²)}SEP=P(y|H,x_{q})={square root over (1/σ_{\hat{p}}_{ₖᵣ}²)}P(y|h,x_{q}) (15)

where

$${σ}_{{\hat{p}}_{kr}}^{2} = {σ}_{\hat{p}}^{2} = \frac{{n}_{t}}{M} for {n}_{t} \neq M and {σ}_{{\hat{p}}_{kr}}^{2} = {σ}_{\hat{p}}^{2} = 2 , for {n}_{t} = M .$$

1. A Multiple rank modulation transmission method in a Multiple-Input Multiple-Output (MIMO) or Multiple-Input Single-Output (MISO) system, the method including:
receiving at a transmitter, a signal with a plurality of bits and separating the received signal into a rank index bit block and a signal modulation bit block;
encoding the signal modulation bit block in a signal modulation scheme for transmission;
using the rank index bit block to select a rank to be activated, wherein the activated rank contains at least one active transmitter antenna; and
transmitting the encoded signal modulation bit block via the activated rank being at least one activated transmitter antenna;
receiving the transmitted encoded signal modulation bit block via the receive antenna and a receiver;
estimating a rank index and a transmitted symbol from the received signal; and
decoding the signal modulation bit block.

2. The method of claim 1 wherein the signal modulation scheme comprises at least one of Binary Phase Shift Keying (BPSK), Quadrature Phase Shift Keying (QPSK), and Quadrature Amplitude Modulation (QAM).

3. The method of claim 1, wherein the encoding of the signal modulation bit block comprises generating a vector signal with as many symbols as a total number of antennas and encoding a symbol at a position corresponding to the index of the rank to be activated in the vector signal to a signal modulation symbol value.

4. The method of claim 3, wherein the encoding of the rank index bit block comprises setting a symbol at a position corresponding to an inactive antenna in the vector signal to 0.

5. The method of claim 1 further comprising:
calculating a detected vector by multiplying a received signal by a channel path gain repeatedly for all ranks wherein a rank indicates a number of active antennas that have transmitted a signal;
estimating a rank index using a maximum absolute value of an independent variable of the detected vector; and
estimating a transmitted symbol using a constellation of a detected column vector.

6. The method of claim 5, wherein the detected vector comprises
$$[ {\hat{k}}_{\hat{r}} ; \hat{j} , {x}_{\hat{q}} ] = arg {min}_{j , q} \sqrt{\hat{\overline{γ}}} {‖ {\hat{h}}_{j , eff} {x}_{q} ‖}_{F}^{2} - 2 Re \{ {y}^{H} {\hat{h}}_{j , eff} {x}_{q} \}$$
where \hat{k}_{\hat{r}} is the estimated rank index, and x_{\hat{q}} is the transmitted symbol and
$$\hat{\overline{γ}} = \frac{\overline{γ}}{r} .$$

7. A Multiple-Input Multiple-Output (MIMO) or Multiple-Input Single-Output (MISO) system using Multiple rank modulation and Multiple rank modulation detection, the system comprising:
a ranking modulator for encoding a multi-symbol signal into an index of an activated rank;
a plurality of transmitter antennas for sending a modulated signal of a signal modulation encoder through one activated rank containing at least one antenna during a unit time;
a plurality of receiver antennas for receiving the modulated signal from the transmitter antennas;
a detector for estimating a rank index and a transmitted symbol from the received signal; and
a ranking demodulator for decoding the signal of the ranking modulator.

8. The system of claim 7, further comprising:
a plurality of other modulators for outputting other modulated signals to the transmitter antennas; and
a plurality of other demodulators for demodulating other signals.

9. The system of claim 8, wherein the Multiple rank modulator comprises:
a space demapper for receiving a signal with a plurality of bits and separating the received signal into a rank bit block and a signal modulation bit block;
a signal modulation encoder for encoding the signal modulation bit block in a signal modulation scheme; and
a rank index encoder for encoding the rank bit block to select the rank index.

10. The system of claim 7, wherein the detector calculates a detected vector by multiplying a received vector by a channel path gain repeatedly, estimates the antenna index using a maximum absolute value of an independent variable of the detected vector, and estimates the transmitted symbol using a constellation of a detected column vector.

11. The system of claim 7, wherein the ranking demodulator decodes the rank bit block using the estimated rank index, decodes the signal modulation bit block using the estimated transmitted symbol, and demodulating a signal comprising a combination of the rank bit block and the signal modulation bit block.
